(19) United States
(12) Patent Application Publication
(10) Pub. No.: US 2025/0138782 A1
(43) Pub. Date: May 1, 2025

(54) METHOD AND APPARATUS FOR CALCULATIONS BASED ON SYSTOLIC ARRAY

(71) Applicant: Research & Business Foundation SUNGKYUNKWAN UNIVERSITY, Suwon-si (KR)

(72) Inventors: Seokin HONG, Suwon-si (KR); Seongwook KIM, Suwon-si (KR); Gwangeun BYEON, Suwon-si (KR); Sihyung KIM, Suwon-si (KR)

(73) Assignee: Research & Business Foundation SUNGKYUNKWAN UNIVERSITY, Suwon-si (KR)

(21) Appl. No.: 18/933,491

(22) Filed: Oct. 31, 2024

(30) Foreign Application Priority Data
Nov. 1, 2023 (KR) 10-2023-0149068

(51) Int. Cl. G06F 7/523; G06F 7/50

(52) U.S. Cl. CPC G06F 7/523; G06F 7/50

(57) ABSTRACT

There is provided an apparatus for calculations based on a systolic array, comprising: a memory in which one or more operand data chunks are stored, a conveyor queue configured to shift the one or more operand data chunks in sequence and one or more synchronous processing units (SPUs) including one or more processing elements (PEs), and configured to access the operand data chunks shifted along the conveyor queue, wherein the one or more processing elements perform calculations based on the operand data chunks that the synchronous processing unit including each processing element has accessed.

### CROSS REFERENCE TO RELATED APPLICATION

The present application claims priority to Korean Patent Application No. 10-2023-0149068, filed on Nov. 1, 2023, the entire contents of which is incorporated herein for all purposes by this reference.

### TECHNICAL FIELD

The present invention relates to a method and apparatus for calculations based on a systolic array.

This work was supported by Institute of Information & communications Technology Planning & Evaluation (IITP) grant funded by the Korea government (Ministry of Science and ICT) (Project unique No.: 1711193550; Project No.: 2021-0-00863-003; R&D project: Development of new concept PIM semiconductor technology; Research Project Title: Intelligent In-Memory Error-Correction Device for High-Reliability Memory; and Project period: 2023.01.01˜2023.12.31), and Institute of Information & communications Technology Planning & Evaluation (IITP) grant funded by the Korea government (Ministry of Science and ICT) (Project unique No.: 1711193592; Project No.: 2021-0-02052-003; R&D project: Information and Communication Broadcasting Innovation Talent Training; Research Project Title: Development of Artificial Intelligence System on Chip Technologies for Smart Mobility: 2023.01.01˜2023.12.31.), and Institute of Information & communications Technology Planning & Evaluation (IITP) grant funded by the Korea government (Ministry of Science and ICT) (Project unique No.: 1711193320; Project No.: 2022-0-01170-002; R&D project: PIM Artificial Intelligence Semiconductor Core Technology Development (Design); Research Project Title: PIM Semiconductor Design Research Center: 2023.01.01˜2023.12.31.).

### BACKGROUND

In artificial neural network algorithms, the convolution layer and fully-connected layer, which are widely used, account for most of the execution time in overall algorithm calculations. In this case, the overall algorithm calculations are converted into matrix multiplication and calculated in hardware. Therefore, most artificial neural network accelerators focus on efficiently processing matrix multiplication calculations. In particular, the systolic array architecture allows fast matrix multiplication calculations to be performed by parallelizing calculations through an array composed of multiple multiply and accumulate (MAC) operator processing elements (PEs). In addition, the systolic array architecture enables direct data shift between adjacent processing elements (PEs), allowing data to be allocated to many operators while reducing memory bandwidth. Due to these advantages, many commercial neural processing units (NPUs) or artificial intelligence accelerators adopt a systolic array-based architecture.

Recently, convolutional neural network (CNN) or deep neural network (DNN) models, which are widely used, have adopted the rectified linear unit (ReLU) as an activation function. In this case, the ReLU function converts all negative values to a zero value, making the activation map matrix sparse. In addition, the weight pruning technique, which is widely used for model compression, removes weak neuron connections from the model, thereby increasing the number of zero values in the weight matrix. Accordingly, matrix multiplication in the process of performing artificial neural network algorithms mostly includes sparse matrix calculations and involves unnecessary multiplication calculations with zero values. For example, in the case of ResNet, a representative CNN model, approximately 59% of the total multiplication calculations were found to be unnecessary.

Conventional systolic array-based accelerators propagate data through a two-dimensional pipeline composed of multiple operators. In this case, to maintain the data flow, unnecessary zero values in the calculations also need to be propagated through the PE array. Therefore, in general systolic array-based accelerators, it is not possible to dynamically skip multiplication calculations with zero values.

To enable skipping unnecessary calculations in a systolic array, each PE needs to receive multiple pieces of data rather than a single piece of data, generate operand pairs dynamically as needed, and perform calculations only on those pairs. However, in this case, each PE calculates a different number of valid operand pairs, which may lead to a pipeline stall due to speed differences between PEs. Adding a first-in, first-out (FIFO) buffer between each PE may help alleviate speed differences by allowing data to be transmitted regardless of whether an adjacent PE has finished its calculations. However, it is not possible for a slower PE to receive data in advance from a relatively faster PE, and there are significant issues with the chip area and power overhead required by the FIFO buffers.

### SUMMARY

The present invention is directed to providing a method and apparatus for calculations based on a systolic array that can dynamically skip unnecessary calculations in a systolic array-based neural network processing unit architecture, thereby achieving a smaller chip area and higher power efficiency compared to conventional systolic array-based neural network processing unit architectures.

However, the problem to be solved by the present disclosure is not limited to that mentioned above, and other problems to be solved that are not mentioned may be clearly understood by those of ordinary skill in the art to which the present disclosure belongs from the following description.

In accordance with an aspect of the present disclosure, there is provided an apparatus for calculations based on a systolic array, comprising: a memory in which one or more operand data chunks are stored, a conveyor queue configured to shift the one or more operand data chunks in sequence and one or more synchronous processing units (SPUs) including one or more processing elements (PEs), and configured to access the operand data chunks shifted along the conveyor queue, wherein the one or more processing elements perform calculations based on the operand data chunks that the synchronous processing unit including each processing element has accessed.

The apparatus may further comprise a conveyor queue controller configured to control the conveyor queue to shift the one or more operand data chunks in response to calculations for the operand data chunks that the one or more synchronous processing units have accessed having been completed.

The one or more processing elements may include a multiply and accumulate (MAC) operator.

The one or more synchronous processing units may be disposed in a row direction and a column direction, and include one or more processing elements disposed in the row direction and one or more processing elements disposed in the column direction.

The one or more operand data chunks may include one or more weight data chunks and one or more activation data chunks. Here, the conveyor queue may include a first conveyor queue configured to shift the one or more weight data chunks by one column in the row direction or by one row in the column direction and a second conveyor queue configured to shift the one or more activation data chunks by one row in the column direction or by one column in the row direction. Also, the conveyor queue controller may control the conveyor queue to shift the one or more weight data chunks by one column in the row direction and the one or more activation data chunks by one row in the column direction, respectively, in response to calculations for the operand data chunk that the one or more synchronous processing units have accessed having been completed, or control the conveyor queue to shift the one or more weight data chunks by one row in the column direction and the one or more activation data chunks by one column in the row direction, respectively.

Each weight data chunk may include unit weight data chunks in the same number as one or more processing elements disposed in a unit row or unit column included in the one or more synchronous processing units. Also, each activation data chunk may include unit activation data chunks in the same number as one or more processing elements disposed in a unit column or unit row included in the one or more synchronous processing units. Here, in the one or more processing elements, processing elements disposed in different columns included in the same synchronous processing unit may perform calculations based on different unit weight data chunks. Also, processing elements disposed in different rows included in the same synchronous processing unit may perform calculations based on different unit activation data chunks.

The one or more synchronous processing units may include a search window designating a range of possible accesses and calculations for the one or more operand data chunks each shifting along the conveyor queue.

The search window may have overlapping areas for adjacent synchronous processing units, and the adjacent synchronous processing units are able to simultaneously access operand data chunks within the overlapping areas.

The one or more processing elements may generate operand data pairs on the basis of the activation data chunk and the weight data chunk that the one or more synchronous processing units have accessed, and perform calculations on operand data pairs that do not have a zero value in the generated operand data pairs.

The one or more synchronous processing units may transmit a shift request signal to the conveyor queue controller, when there is an operand data chunk inside the search window for which the calculations have been completed, and access a next operand data chunk inside the search window. Here, the conveyor queue controller may control the conveyor queue to shift the one or more operand data chunks in response to receiving the shift request signal from all synchronous processing units.

When the one or more operand data chunks are shifted by the conveyor queue, the conveyor queue controller may transmit a shift completion signal to all the synchronous processing units, and in response to receiving the shift completion signal, all the synchronous processing units may increment a value of position information on data being calculated by the one or more processing elements by one.

In accordance with another aspect of the present disclosure, there is provided a method for calculations based on a systolic array including a conveyor queue, one or more processing elements, and one or more synchronous processing units, the method comprising, shifting, by the conveyor queue, one or more operand data chunks in sequence, accessing, by the one or more processing elements, the operand data chunks shifted along the conveyor queue and performing, by the one or more processing elements, calculations based on the accessed operand data chunks.

In accordance with another aspect of the present disclosure, there is provided a non-transitory computer-readable storage medium storing a computer program, wherein the computer program, when executed by a processor, comprises an instruction for causing the processor to perform a method comprises shifting, by a conveyor queue, one or more operand data chunks in sequence, accessing, by one or more processing elements, the operand data chunks shifted along the conveyor queue and performing, by the one or more processing elements, calculations based on the accessed operand data chunks.

According to the present invention, it is possible to dynamically skip unnecessary calculations in a systolic array-based neural network processing unit architectures, thereby improving the efficiency of sparse matrix multiplication calculations. In addition, it is possible to achieve a smaller chip area and higher power efficiency compared to existing systolic array-based neural network processing unit architectures that use FIFO buffers to resolve load imbalance between processing elements.

### BRIEF DESCRIPTION OF THE DRAWINGS

FIG. 1 is a flowchart illustratively showing an apparatus for calculations based on a systolic array according to a first aspect of the present invention.

FIG. 2 is a block diagram exemplarily illustrating a function of a systolic array-based calculation program.

FIG. 3 is an exemplified view illustrating an embodiment of an apparatus for calculations based on a systolic array, according to the present invention.

FIG. 4 is an exemplified view illustrating that, in an embodiment of an apparatus for calculations based on a systolic array according to the present invention, a synchronous processing unit and a processing element access operand data chunks shifted along with a conveyor queue.

FIG. 5 is an exemplified view illustrating that in a conveyor queue, a synchronous processing unit accesses operand data chunks through a search window.

FIG. 6 is an exemplified view illustrating that the search windows of adjacent synchronous processing units have overlapping areas, resulting in the sharing of a specific operand data chunk.

FIG. 7 is a block diagram exemplarily illustrating a method of calculations based on a systolic array according to a second aspect of the present invention.

FIG. 8 is a graph illustrating the performance difference between an accelerator according to the present invention and a conventional accelerator for a CNN model.

FIG. 9 is a graph illustrating the performance difference between an accelerator according to the present invention and a conventional accelerator when 50% weight pruning is applied.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

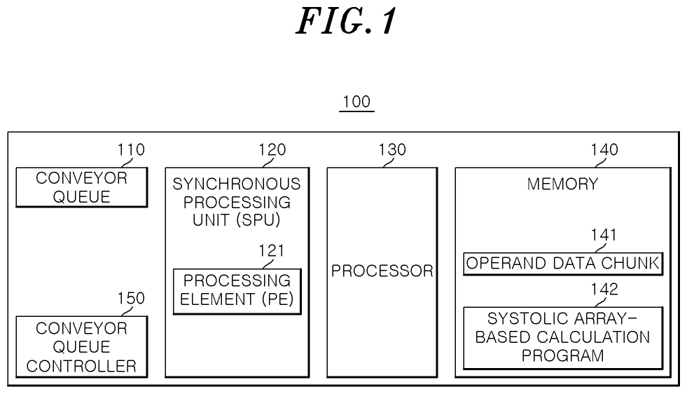

FIG. 1 is a flowchart exemplarily illustrating an apparatus for calculations based on a systolic array according to a first aspect of the present invention.

As illustrated in FIG. 1, an apparatus 100 for calculations based on a systolic array may include a conveyor queue 110, a synchronous processing unit 120, a processor 130, a memory 140, and a conveyor queue controller 150. In addition, the synchronous processing unit may include one or more processing elements 121. In addition, the memory 140 may include an operand data chunk 141, a systolic array-based calculation program 142.

In a systolic array within the apparatus 100 for calculations based on a systolic array of the present invention, one or more synchronous processing units 120 may be disposed adjacent to and connected to each other.

In the present invention, a pipeline register in which the operand data chunk 141 is buffering in the systolic array may be separated from the processing element 121 array and reconfigured as the conveyor queue 110. That is, in the conventional systolic array, data such as weights, input features, and partial sums were transmitted between adjacent disposed processing elements. However, in the present invention, the operand data chunk 141 may be transmitted through the conveyor queue 110.

The synchronous processing unit 120 may include one or more processing elements 121 therein. That is, the one or more processing elements 121 may be configured in a unit of the synchronous processing unit 120.

The processing element 121 is a MAC operator and may perform the functions of an adder and a multiplier.

The processing element 121 may generate operand data pairs on the basis of an activation data chunk and a weight data chunk accessed by the synchronous processing unit 120, and perform calculations only on operand data pairs that do not contain a zero value in the generated operand data pairs.

The conveyor queue 110 may fetch the operand data chunk 141 from the memory 140 and propagate the operand data chunk 141 in a row or a column direction of the synchronous processing unit 120 or processing element 121 array. In this case, the synchronous processing unit 120 or the processing element 121 may fetch the operand data chunk 141 for use in calculations from a specific point in the connected conveyor queue 110. Accordingly, even if the synchronous processing unit 120 or processing element 121 does not directly propagate the operand data chunk 141, which has completed calculations, to the adjacent synchronous processing unit 120 or processing element 121, the adjacent synchronous processing unit 120 or processing element 121 may perform calculations using the operand data chunk 141 propagated through the conveyor queue 110.

Each synchronous processing unit 120 or processing element 121 may have a unique search window allocated, respectively for fetching the operand data chunk 141 from the conveyor queue 110. In this case, the search window may designate a range of possible accesses and calculations for the operand data chunk 141 shifted through the conveyor queue 110 for the synchronous processing unit 120 or processing element 121.

The synchronous processing unit 120 or processing element 121 may only access the operand data chunk 141 that is within the search window corresponding to each synchronous processing unit 120 or processing element 121. In this case, there may be one or more operand data chunks 141 within the search window corresponding to each synchronous processing unit 120 or processing element 121.

The search window may have an overlapping area for adjacent synchronous processing units 120. Adjacent synchronous processing units 120 may simultaneously access the operand data chunk 141 within the overlapping area. Accordingly, the processing element 121 may perform calculations simultaneously using the operand data chunk 141 that has been accessed at the same time.

The synchronous processing unit 120 may transmit a shift request signal to the conveyor queue controller 150 whenever all processing elements 121 included in the same synchronous processing unit 120 complete calculations on each operand data chunk 141 within the search window, and then access the next operand data chunk 141 within the search window. That is, when there is an operand data chunk within the search window for which calculations have been completed, the synchronous processing unit 120 may transmit a shift request signal to the conveyor queue controller 150 and access the next operand data chunk 141 within the search window.

The conveyor queue controller 150 may propagate the operand data chunk 141 by shifting the operand data chunk 141 in the conveyor queue 110 in the row or column direction only when there is an operand data chunk 141 for which calculations have been completed in the search windows of all synchronous processing units 120 or processing elements 121 connected to the conveyor queue 110.

Each synchronous processing unit 120 or processing element 121 may transmit information to the conveyor queue controller 150 regarding the extent to which the operand data chunk 141 has been read in the current search window.

The synchronous processing unit 120 may transmit a shift request signal to the conveyor queue controller 150 whenever all processing elements 121 included in the same synchronous processing unit 120 complete calculations on each operand data chunk 141 within the search window. That is, when there is an operand data chunk within the search window for which calculations have been completed, the synchronous processing unit 120 may transmit a shift request signal to the conveyor queue controller 150. In addition, the conveyor queue controller 150 may control the conveyor queue 110 to shift the operand data chunk 141 in response to receiving shift request signals from all synchronous processing units 120.

The search windows between adjacent synchronous processing units 120 or processing elements 121 may overlap to enable sharing of the operand data chunk 141 between adjacent synchronous processing units 120 or processing elements 121. By overlapping the search windows between adjacent synchronous processing units 120 or processing elements 121, pipeline stalling may be prevented even if a speed difference occurs between adjacent synchronous processing units 120 or processing elements 121.

For example, a synchronous processing unit 120 or processing element 121 having a relatively faster computational rate shares a certain amount of operand data chunks 141 with an adjacent synchronous processing unit 120 or processing element 121. Therefore, the synchronous processing unit 120 or processing element 121 having a slower computational rate may pull and use the operand data chunk 141 currently being processed for calculations. That is, without needing to wait for the completion of calculations by the synchronous processing unit 120 or processing element 121 having a slower computational rate, the operand data chunk 141 used in the corresponding calculation may be accessed and used in calculations.

In contrast, while the synchronous processing unit 120 or processing element 121 having a relatively slower computational rate is performing calculations using a specific operand data chunk 141, even if an adjacent synchronous processing unit 120 or processing element 121 completes its calculations and uses the specific operand data chunk 141 in the next calculation, both the adjacent synchronous processing unit 120 or processing element 121 may continue performing calculations without stalling.

The operand data chunk 141 may refer to data on which calculations are performed through the processing element 121.

The operand data chunk 141 may be configured as a collection of one or more operand data units. For example, when one operand data unit is four bytes, the operand data chunk 141 may be a 16-byte data set configured as a collection of four operand data units.

The operand data chunk 141 may include a weight data chunk, and an activation data chunk. Here, activation data may refer to input features. In addition, weight data is a type of kernel data and may refer to the information multiplied by the input features.

The conveyor queue controller 150 may control the conveyor queue 110 to shift the operand data chunk 141 depending on whether the calculations on the operand data chunk 141 accessed by the synchronous processing unit 120 has been completed.

The conveyor queue controller 150 may transmit a shift completion signal to all synchronous processing units 120 when the conveyor queue 110 shifts the operand data chunk 141. In this case, all synchronous processing units 120 may, in response to receiving a shift completion signal, increment a value of position information on the data being calculated by the processing element by one.

The processor 130 may overally control the operations of the apparatus 100 for calculations based on a systolic array to perform the present invention.

The processor 130 may load the systolic array-based calculation program 142 and the information required for executing the systolic array-based calculation program 142 from the memory 140 to execute the systolic array-based calculation program 142.

The processor 130 may control the storage of data received from an external device, either through a communication device or directly, in the memory 140. In addition, the processor 130 may control the output of information used in systolic array-based calculations or including calculation results to an external device, either through a communication device or directly.

The processor 130 may refer to a processing device such as a microprocessor, a central processing unit (CPU), a graphic processing unit (GPU), a processor core, a multiprocessor, an application-specific integrated circuit (ASIC), a field programmable gate array (FPGA), a micro control unit unit (MCU), and the like, but is not limited to the embodiments described above.

The memory 140 may store the systolic array-based calculation program 142 and the information required for executing the systolic array-based calculation program 142. In addition, the memory 140 may store a processing result by the processor 130.

The systolic array-based calculation program 142 may refer to software that includes instructions programmed to perform systolic array-based calculation tasks.

The memory 140 may store information used in systolic array-based calculations or including calculation results. In addition, the memory 140 may store information received from an external device either through a communication device or directly.

The memory 140 may refer to a computer-readable storage medium, like a hardware device and the like specifically configured to store and execute program instructions, such as magnetic media such as a hard disk, a floppy disk, and a magnetic tape, optical media such as CD-ROM and DVD, magneto-optical media such as a floptical disk, volatile memory such as dynamic random access memory (DRAM) and static random access memory (SRAM), and flash memory, but is not limited to the embodiments described above.

The information stored in the memory 140 includes all information related to the present invention and is not limited to the embodiments described above.

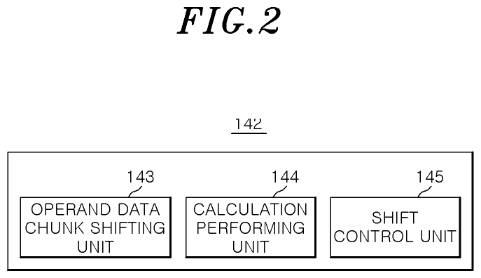

The functions or operations of the systolic array-based calculation program 142 will be described in detail with reference to FIG. 2.

FIG. 2 is a block diagram exemplarily illustrating a function of a systolic array-based calculation program.

As illustrated in FIG. 2, the systolic array-based calculation program 142 may include an operand data chunk shifting unit 143, a calculation performing unit 144, and a shift control unit 145. The operand data chunk shifting unit 143, calculation performing unit 144, and shift control unit 145 are exemplary divisions of the functions of the systolic array-based calculation program 142 and are not limited thereto.

According to the embodiment, the functions of the operand data chunk shifting unit 143, calculation performing unit 144, and shift control unit 145 may be merged or separated, and may be implemented as a series of instructions included in a single program.

The operand data chunk shifting unit 143, calculation performing unit 144, and shift control unit 145 may be implemented by the processor 130 and may refer to a data processing device embedded in hardware, having a physically structured circuit for performing functions expressed by code or instructions included in the systolic array-based calculation program 142 stored in the memory 140.

The operand data chunk shifting unit 143 may sequentially shift the operand data chunk in the row or column direction and propagate the operand data chunk required for the calculations of the calculation performing unit 144 to the synchronous processing unit or processing element.

The operand data chunk shifting unit 143 may shift the operand data chunk by one column in the row direction or by one row in the column direction.

The calculation performing unit 144 may perform calculations based on the operand data chunk shifted by the operand data chunk shifting unit 143.

The calculation performing unit 144 may perform the function of a MAC operator.

The calculation performing unit 144 may transmit a shift request signal to the shift control unit 145 whenever all processing elements included in the same synchronous processing unit complete calculations on each operand data chunk within the search window, and may then access the next operand data chunk within the search window. That is, when there is an operand data chunk within the search window for which calculations have been completed, the calculation performing unit 144 may transmit a shift request signal to the shift control unit 145 and access the next operand data chunk within the search window.

The shift control unit 145 may control the operand data chunk shifting unit 143 to shift the operand data chunk in the row or column direction depending on whether the calculations by the calculation performing unit 144 have been completed.

The shift control unit 145 may control the operand data chunk shifting unit 143 to shift the operand data chunk in response to receiving shift request signals for all synchronous processing units from the calculation performing unit 144.

The shift control unit 145 may transmit a shift completion signal to all synchronous processing units when the operand data chunk shifting unit 143 shifts the operand data chunk. In this case, all synchronous processing units may, in response to receiving the shift completion signal from the shift control unit 145, increment the value of the position information for the data being calculated by the processing element by one.

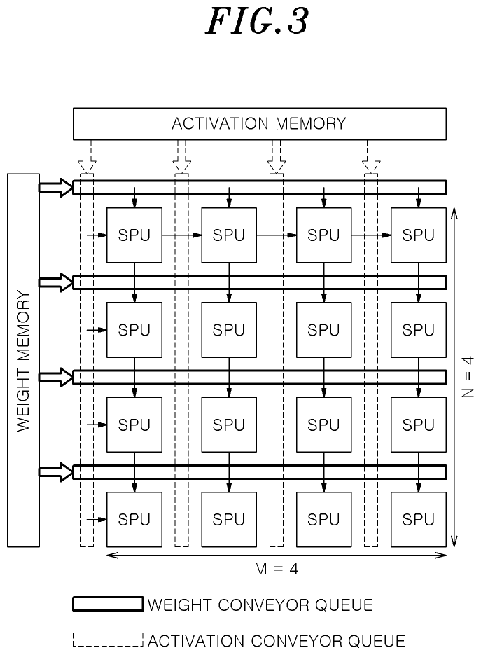

FIG. 3 is an exemplified view illustrating an embodiment of an apparatus for calculations based on a systolic array, according to the present invention. In the description of the present invention, the systolic array architecture with a conveyor queue applied will be referred to as Conveyor-SA. FIG. 3 illustrates an exemplary structure of the Conveyor-SA.

As illustrated in FIG. 3, the apparatus for calculations based on a systolic array according to the present invention may include a synchronous processing unit (SPU) for performing calculations, a memory storing operand data chunks, and a conveyor queue that fetches operand data chunks from the memory and propagates the operand data chunks to the synchronous processing unit.

The synchronous processing unit may be disposed in the row or column direction.

A weight conveyor queue may propagate weight data chunks stored in weight memory to each synchronous processing unit while shifting the weight data chunks through the weight conveyor queue.

An activation conveyor queue may propagate activation data chunks stored in activation memory to each synchronous processing unit while shifting the activation data chunks through the activation conveyor queue.

The synchronous processing unit may perform calculations based on the weight data chunk and activation data chunk shifted along with the weight conveyor queue and activation conveyor queue.

In FIG. 3, for convenience of description, the memory is divided into the activation memory and weight memory, but it is not limited thereto. That is, a form in which both the activation data chunk and weight data chunk are stored in a single memory, or a form in which the activation data chunk or weight data chunk are distributed and stored in multiple memories, are also possible. In FIG. 3, for convenience of description, the weight conveyor queue is described as propagating weight data chunks in the row direction, and the activation conveyor queue is described as propagating activation data chunks in the column direction, but it is not limited thereto. That is, according to the embodiment, the direction in which the weight conveyor queue and the activation conveyor queue propagate each data chunk may change.

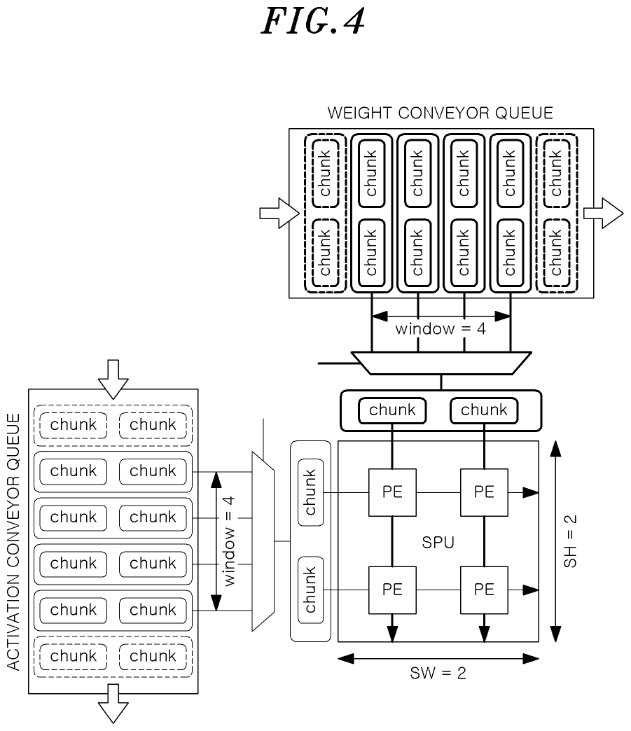

FIG. 4 is an exemplified view illustrating that, in an embodiment of an apparatus for calculations based on a systolic array according to the present invention, a synchronous processing unit and a processing element (PE) access operand data chunks shifted along with a conveyor queue.

One or more processing elements may be grouped in a unit of a synchronous processing unit.

As illustrated in FIGS. 3 and 4, the synchronous processing unit may be disposed in the row and column directions, and may include one or more processing elements disposed in the row direction and one or more processing elements disposed in the column direction.

There are no pipeline registers between the processing elements within the same synchronous processing unit, and the weight data chunk and activation data chunk may be propagated to the processing elements in the same row or column through the conveyor queue.

A conveyor queue that propagates weight data chunks and activation data chunks may exist between synchronous processing units. The synchronous processing unit may fetch an operand data chunk from the search window within the conveyor queue and allocate the operand data chunk to the processing element.

Unlike a conventional systolic array, direct data transmission and reception between adjacent synchronous processing units is not possible, and data propagation may only be performed through the conveyor queue.

The conveyor queue may shift the weight data chunk or activation data chunk in the row or column direction. For example, the conveyor queue may shift the weight data chunk by one column in the row direction. For another example, the conveyor queue may shift the activation data chunk by one row in the column direction.

The operand data chunk may include the same number of unit operand data chunks as the number of one or more processing elements disposed in a unit row or unit column included in the synchronous processing unit. For example, when one synchronous processing unit is configured as a total of four processing elements in a 2 by 2 matrix form, since there are two processing elements disposed in one row or column included in one synchronous processing unit, the operand data chunk may include two unit operand data chunks.

The weight data chunk may include the same number of unit weight data chunks as the number of one or more processing elements disposed in the unit row included in the synchronous processing unit 120. For example, when one synchronous processing unit is configured as a total of four processing elements in a 2 by 2 matrix form, since there are two processing elements disposed in one row included in one synchronous processing unit 120, the weight data chunk may include two unit weight data chunks.

The activation data chunk may include the same number of unit activation data chunks as the number of one or more processing elements disposed in the unit column included in the synchronous processing unit. For example, when one synchronous processing unit is configured as a total of four processing elements in a 2 by 2 matrix form, since there are two processing elements disposed in one column included in one synchronous processing unit, the activation data chunk may include two unit activation data chunks.

In FIG. 4, the synchronous processing unit is configured as four processing elements disposed in a 2 by 2 matrix form. Therefore, since there are two processing elements that configure the unit row or unit column within the synchronous processing unit, each weight data chunk and each activation data chunk may be configured as two unit weight data chunks and two unit activation data chunks, respectively. Each unit weight data chunk and each unit activation chunk propagated to the same unit processing unit may be different from one another.

Accordingly, the two processing elements positioned in a first row within the synchronous processing unit may receive and share a first unit activation data chunk propagated in the row direction, while the two processing elements positioned in a second row may receive and share a second unit activation data chunk propagated in the row direction. Likewise, the two processing elements positioned in a first column within the synchronous processing unit may receive and share a first unit weight data chunk propagated in the column direction, while the two processing elements positioned in a second column may receive and share a second unit weight data chunk propagated in the column direction. That is, a processing element disposed in a different column included in the same synchronous processing unit may perform calculations based on a different unit weight data chunk, and a processing element disposed in a different row included in the same synchronous processing unit may perform calculations based on a different unit activation data chunk. Therefore, since the processing elements included in one synchronous processing unit perform calculations based on different operand data, calculations may be performed in parallel without redundant calculations.

When a difference in calculation speed occurs between processing elements within the synchronous processing unit, the processing elements may wait until a processing element having the slowest computational rate completes its calculations. Therefore, all processing elements within the synchronous processing unit may perform calculations in synchronization.

Each processing element may accumulate the results of calculations in a partial sum register. In this case, to dynamically skip unnecessary calculations for an operand data chunk that includes a zero value, each processing element may receive an operand data chunk that includes a weight data chunk and an activation data chunk including multiple values. The processing element may generate operand data pairs that are not a zero value while cycling through the operand data chunk, and accumulate the results of multiplying the operand data pairs in the partial sum register in sequence.

The conveyor queue controller 150 may control the conveyor queue to shift one or more operand data chunks in response to completion of calculations on operand data chunks accessed by one or more synchronous processing units.

Specifically, the conveyor queue controller 150 may control the conveyor queue to shift the weight data chunk by one column in the row direction and the activation data chunk by one row in the column direction, respectively, in response to completion of calculations on the operand data chunk accessed by the synchronous processing unit. In contrast, the conveyor queue controller 150 may control the conveyor queue to shift the weight data chunk by one row in the column direction and the activation data chunk by one column in the row direction, respectively, in response to completion of calculations on the operand data chunk accessed by the synchronous processing unit.

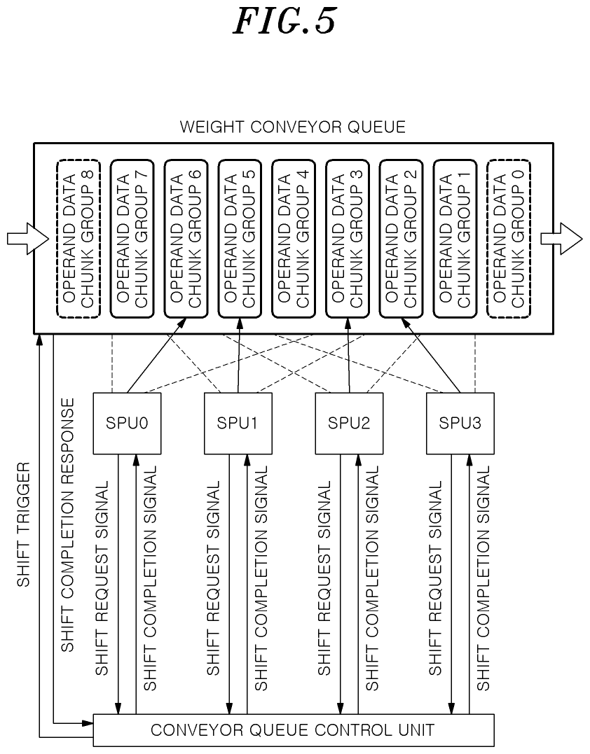

FIG. 5 is an exemplified view illustrating that in a conveyor queue, a synchronous processing unit accesses operand data chunks through a search window. In FIG. 5, it will be described by referring to each operand data chunk as an operand data chunk group on the premise that each operand data chunk includes one or more unit operand data chunks.

FIG. 5 exemplarily illustrates that multiple synchronous processing units access operand data chunk groups required for calculations in the conveyor queue, and the conveyor queue controller 150 controls the conveyor queue on the basis of the shift request signal received from each synchronous processing unit.

The conveyor queue may shift the operand data group only when all synchronous processing units connected to the conveyor queue have the operand data group for which calculations have been completed.

Each synchronous processing unit may store the position of the operand data chunk group currently performing calculations (as indicated by arrows in FIG. 5).

Each synchronous processing unit may transmit a shift request signal to the conveyor queue controller 150 when the operand data chunk group currently performing calculations is not at the end of the search window. That is, the synchronous processing unit may determine that a new operand data chunk group may be fetched when there is available space remaining in the current search window and generate a shift request signal.

In response to receiving the shift request signal from all connected synchronous processing units, the conveyor queue controller 150 may generate a shift trigger signal to control the conveyor queue to shift the operand data chunk group.

The conveyor queue controller 150 may transmit a shift completion signal to each synchronous processing unit after the operand data chunk group has been shifted, notifying that the operand data chunk group has been shifted.

Each synchronous processing unit may increment the location of the operand data chunk group currently performing calculations by one in order to align the position of the operand data chunk group currently performing calculations with the operand data chunk group previously being calculated, even after the conveyor queue has shifted the data.

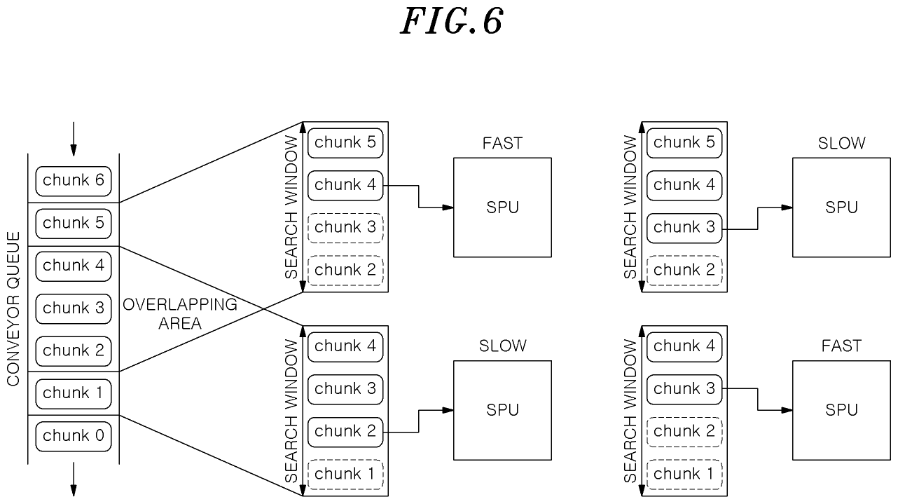

FIG. 6 is an exemplified view illustrating that the search windows of adjacent synchronous processing units have overlapping areas, resulting in the sharing of a specific operand data chunk.

The processing element may generate operand data pairs on the basis of the activation data chunk and weight data chunk accessed by the synchronous processing unit and may perform calculations only on the operand data pairs that do not contain a zero value in the generated operand data pairs. Here, operand data pairs that do not contain a zero value will be referred to as valid operand data pairs.

Since the synchronous processing unit performs calculations based on different weight data and activation data, the synchronous processing unit may process a different number of valid operand data pairs.

The number of clock cycles required for calculations is determined by the number of valid operand data pairs, which may result in differences in calculation speed between adjacent synchronous processing units.

The conveyor queue may need to receive a shift request signal from all synchronous processing units in order to shift the operand data chunk. Accordingly, the shift speed of the operand data chunk in the conveyor queue may be synchronized with the slowest synchronous processing unit. Therefore, the slower calculation speed of a synchronous processing unit may cause underutilization of the remaining synchronous processing units. Accordingly, to improve the overall performance of the systolic array, it is necessary to alleviate the speed differences between synchronous processing units and ensure that the relatively faster synchronous processing units are utilized. To this end, in Conveyor-SA, adjacent synchronous processing units may share a certain area of the search window.

FIG. 6 illustrates the resolution of the underutilization issue that may be caused by the slowest synchronous processing unit when adjacent synchronous processing units share the search window with each other.

For example, each search window may include four operand data chunks, and adjacent search windows may share three operand data chunks.

All synchronous processing units may fetch operand data chunks from the search window and perform calculations regardless of the state of adjacent synchronous processing units. In this case, if adjacent synchronous processing units are in a producer-consumer relationship, the following scenarios may occur.
Scenario 1: When the producer is faster than the consumer (fast-slow relationship)
Scenario 2: When the producer is slower than the consumer (slow-fast relationship)

Here, Scenario 1 corresponds to the left side of FIG. 6, and Scenario 2 corresponds to the right side of FIG. 6. The upper synchronous processing unit represents the producer, while the lower synchronous processing unit represents the consumer.

In the conventional systolic array, when the two scenarios occur, the pipeline may stall to maintain data flow.

In contrast, according to the present invention, when adjacent synchronous processing units share a certain amount of operand data chunks, the relatively faster synchronous processing unit may be utilized without stalling the pipeline, as follows.
Scenario 1: Even though the adjacent consumer has not completed its calculations, the producer may process the next operand data chunk.
Scenario 2: Even though the adjacent producer has not completed its calculations, the consumer may process the next operand data chunk.

That is, even if there is a difference in calculation speed between adjacent synchronous processing units, the adjacent synchronous processing units may simultaneously access operand data chunks within the overlapping area of the search windows and perform calculations. As a result, the pipeline may continue performing calculations without stalling.

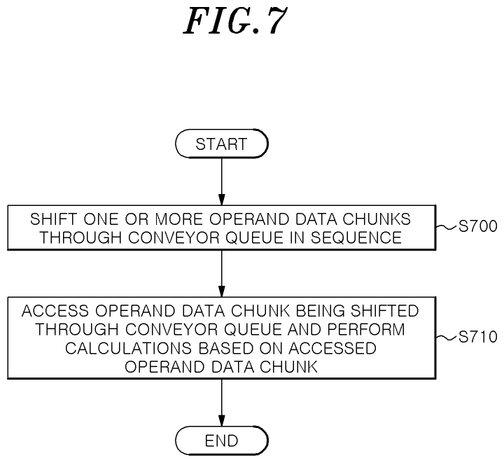

FIG. 7 is a block diagram exemplarily illustrating a method of calculations based on a systolic array according to a second aspect of the present invention.

As illustrated in FIG. 7, there is provided a method of calculations based on a systolic array performed on an apparatus for calculations based on a systolic array including a conveyor queue, one or more processing elements, and one or more synchronous processing units, according to a second aspect of the present invention. The method may include shifting, by the conveyor queue, one or more operand data chunks in sequence (S700); accessing, by the one or more processing elements, the operand data chunks shifted through the conveyor queue and performing, by the one or more processing elements, calculations based on the accessed operand data chunks (S710).

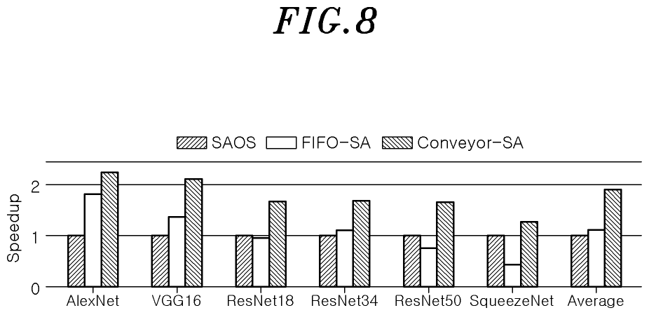

FIG. 8 is a graph illustrating the performance difference between an accelerator according to the present invention and a conventional accelerator for a CNN model.

As illustrated in FIG. 8, it can be seen that the Conveyor-SA architecture demonstrates performance that is on average 1.90 times faster compared to the SA (conventional SA structure) and 1.71 times faster compared to the FIFO-SA (SA structure with FIFO buffers).

In case that convolutional layers are stacked in a simple manner, such as in AlexNet or VGG16, a relatively high average performance gain of 2.18 times was observed compared to the conventional systolic array. For models with low sparsity in activation data or those that include depthwise convolutional layers, a relatively lower performance gain of 1.57 times was observed.

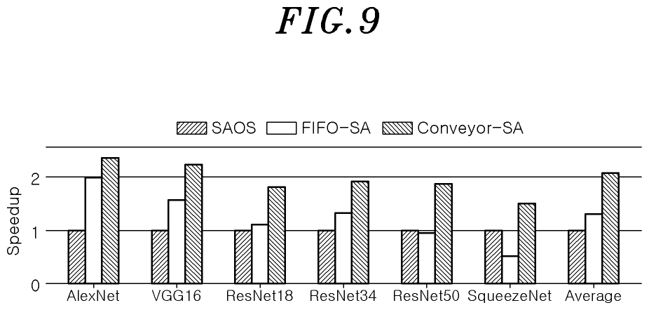

FIG. 9 is a graph illustrating the performance difference between an accelerator according to the present invention and a conventional accelerator when 50% of weight pruning is applied.

To analyze the performance gains according to the sparsity of weight data, unstructured pruning was applied to approximately 50% of the weight.

According to FIG. 9, when weight pruning was applied, the overall performance gain was observed to be on average 2.07 times compared to SA and 1.58 times compared to FIFO-SA.

Table 1 shows the results of the hardware overhead analysis between FIFO-SA and Conveyor-SA.

TABLE 1

| | |
|---|---|
| FIFO-SA | Conveyor-SA |

| | Power | | Power |
|---|---|---|---|
| Chip area | consumption | Chip area | consumption |
| 4.20 mm² | 1067.27 mW | 3.38 mm² | 811.11 mW |

As shown in Table 1, the apparatus for calculations based on a systolic array using the Conveyor-SA according to the present invention can be implemented with a smaller chip area and lower power consumption compared to the apparatus for calculations based on a systolic array using conventional FIFO buffers.

As described above, according to the present invention, it is possible to dynamically skip unnecessary calculations in a systolic array-based neural network processing unit structure, thereby improving the efficiency of sparse matrix multiplication calculations. In addition, it is possible to achieve a smaller chip area and higher power efficiency compared to existing systolic array-based neural network processing unit structures that use FIFO buffers to resolve load imbalance between processing elements.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An apparatus for calculations based on a systolic array, comprising:
a memory in which one or more operand data chunks are stored;
a conveyor queue configured to shift the one or more operand data chunks in sequence; and
one or more synchronous processing units (SPUs) including one or more processing elements (PEs), and configured to access the operand data chunks shifted along the conveyor queue,
wherein the one or more processing elements perform calculations based on the operand data chunks that the synchronous processing unit including each processing element has accessed.

2. The apparatus of claim 1, further comprising:
a conveyor queue controller configured to control the conveyor queue to shift the one or more operand data chunks in response to calculations for the operand data chunks that the one or more synchronous processing units have accessed having been completed.

3. The apparatus of claim 2, wherein the one or more processing elements include a multiply and accumulate (MAC) operator.

4. The apparatus of claim 3, wherein the one or more synchronous processing units are disposed in a row direction and a column direction, and include one or more processing elements disposed in the row direction and one or more processing elements disposed in the column direction.

5. The apparatus of claim 4, wherein the one or more operand data chunks include one or more weight data chunks and one or more activation data chunks,
wherein the conveyor queue includes:
a first conveyor queue configured to shift the one or more weight data chunks by one column in the row direction or by one row in the column direction; and
a second conveyor queue configured to shift the one or more activation data chunks by one row in the column direction or by one column in the row direction,
wherein the conveyor queue controller controls the conveyor queue to shift the one or more weight data chunks by one column in the row direction and the one or more activation data chunks by one row in the column direction, respectively, in response to calculations for the operand data chunk that the one or more synchronous processing units have accessed having been completed, or
controls the conveyor queue to shift the one or more weight data chunks by one row in the column direction and the one or more activation data chunks by one column in the row direction, respectively.

6. The apparatus of claim 5, wherein each weight data chunk includes unit weight data chunks in the same number as one or more processing elements disposed in a unit row or unit column included in the one or more synchronous processing units,
wherein each activation data chunk includes unit activation data chunks in the same number as one or more processing elements disposed in a unit column or unit row included in the one or more synchronous processing units,
wherein, in the one or more processing elements, processing elements disposed in different columns included in the same synchronous processing unit perform calculations based on different unit weight data chunks, and
wherein processing elements disposed in different rows included in the same synchronous processing unit perform calculations based on different unit activation data chunks.

7. The apparatus of claim 6, wherein the one or more synchronous processing units include a search window designating a range of possible accesses and calculations for the one or more operand data chunks each shifting along the conveyor queue.

8. The apparatus of claim 7, wherein the search window has overlapping areas for adjacent synchronous processing units, and the adjacent synchronous processing units are able to simultaneously access operand data chunks within the overlapping areas.

9. The apparatus of claim 7, wherein the one or more processing elements generate operand data pairs on the basis of the activation data chunk and the weight data chunk that the one or more synchronous processing units have accessed, and perform calculations on operand data pairs that do not have a zero value in the generated operand data pairs.

10. The apparatus of claim 7, wherein the one or more synchronous processing units transmit a shift request signal to the conveyor queue controller, when there is an operand data chunk inside the search window for which the calculations have been completed, and access a next operand data chunk inside the search window, and
wherein the conveyor queue controller controls the conveyor queue to shift the one or more operand data chunks in response to receiving the shift request signal from all synchronous processing units.

11. The apparatus of claim 10, wherein when the one or more operand data chunks are shifted by the conveyor queue, the conveyor queue controller transmits a shift completion signal to all the synchronous processing units, and in response to receiving the shift completion signal, all the synchronous processing units increment a value of position information on data being calculated by the one or more processing elements by one.

12. A method for calculations based on a systolic array performed on a calculating apparatus based on a systolic array including a conveyor queue, one or more processing elements, and one or more synchronous processing units, the method comprising:
shifting, by the conveyor queue, one or more operand data chunks in sequence;
accessing, by the one or more processing elements, the operand data chunks shifted along the conveyor queue; and
performing, by the one or more processing elements, calculations based on the accessed operand data chunks.

13. A computer-readable storage medium storing computer-executable instructions, the computer-executable instructions, when executed by a processor, allowing the processor to perform a method comprising:
shifting, by a conveyor queue, one or more operand data chunks in sequence;
accessing, by one or more processing elements, the operand data chunks shifted along the conveyor queue; and
performing, by the one or more processing elements, calculations based on the accessed operand data chunks.
